(19) United States
(12) Patent Application Publication
(10) Pub. No.: US 2009/0208611 A1
(43) Pub. Date: Aug. 20, 2009

(54) Food Product

(76) Inventor: Mary Elizabeth Williams, Temple Hills, MD (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 12/032,873

(22) Filed: Feb. 18, 2008

(51) Int. Cl. A23G 9/34; A23L 1/212; A23G 9/00

(52) U.S. Cl. 426/100; 426/615; 426/519; 426/534; 426/506

(57) ABSTRACT

Disclosed are a food product and a method of preparing the food product. The food product includes at least one fruit and at least one fruit juice. The at least one fruit juice is mixed with the at least one fruit for forming a mixture. Thereafter, the mixture is frozen to prepare the food product. The food product is provided with a food product package.

### FIELD OF THE INVENTION

The present invention relates generally to a food product, and more particularly to a food product.

### BACKGROUND OF THE INVENTION

It is a well known fact that following a healthy diet enables people to remain healthy. Generally, people consume food products such as desserts, as they are delicious. These desserts usually include ingredients, such as sugar, cheese, cakes, cookies, pastries, creams, egg whites, candies, and the like. However, consumption of these desserts may enhance health problems in consumers.

More specifically, excessive consumption these desserts, for example, pastries and candies, may affect the teeth of a consumer. Moreover, excessive consumption of such desserts may lead to other health problems such as heart disease, obesity and the like. Further, preparation of such desserts is usually time-consuming.

Accordingly, there is a need for a food product, more specifically, a dessert, that may be healthy for human consumption. Further, there is a need for a food product that may be easy to prepare.

### SUMMARY OF THE INVENTION

In view of the foregoing disadvantages inherent in the prior art, the general purpose of the present invention is to provide a food product that is configured to include all advantages of the prior art, and to overcome the drawbacks inherent therein.

Accordingly, an object of the present invention is to provide a food product, more specifically, a dessert that may be healthy for human consumption.

Another object of the present invention is to provide a convenient method for preparing a food product.

In light of the above objects, in one aspect of the present invention, a food product is disclosed. The food product is capable of reducing probabilities of affecting a diet and health of a consumer. The food product includes at least one fruit and at least one fruit juice. The at least one fruit juice is mixed with the at least one fruit to form a mixture. The mixture is then frozen to form the food product.

In another aspect of the present invention, a food product package is provided. The food product package includes a food product and a holder. The food product may be prepared by freezing a mixture of at least one fruit and at least one fruit juice. Moreover, the holder may accommodate the food product, thereby forming the food product package. The holder enables a consumer to conveniently hold and consume the food product.

In yet another aspect of the present invention, a method of preparing a food product is disclosed. The method includes adding at least one fruit into a container. Thereafter, at least one fruit juice may be added to the at least one fruit contained in the container. Subsequently, the at least one fruit juice and the at least one fruit may be agitated within the container to form a mixture. Finally, the mixture may be frozen to prepare the food product.

These together with the other aspects of the present invention, along with the various features of novelty that characterize the present invention, are pointed out with particularity in the claims annexed hereto and form a part of the present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates a perspective view of a food product in a frozen form, in accordance with an exemplary embodiment of the present invention;

FIG. 2 illustrates a perspective view of a food product blended with a drink, in accordance with another embodiment of the present invention;

FIG. 3 illustrates a perspective view of a food product including a garnishing material, in accordance with an embodiment of the present invention;

FIG. 4 illustrate perspective view of a food product package, in accordance with an exemplary embodiment of the present invention; and

FIG. 5 illustrates a flow chart depicting a method for preparing a food product, in accordance with an exemplary embodiment of the present invention.

Like reference numerals refer to like parts throughout the description of several views of the drawings.

### DETAILED DESCRIPTION OF THE INVENTION

For a thorough understanding of the present invention, reference is to be made to the following detailed description, including the appended claims, in connection with the above-described drawings. Although the present invention is described in connection with exemplary embodiments, the present invention is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “a” and “an” herein do not denote a limitation of quantity, but rather denote the presence of at least one of the referenced item.

The present invention provides a food product. The food product includes ingredients, such as fresh fruits that are healthy for human consumption. Moreover, the food product is easy to prepare and consume.

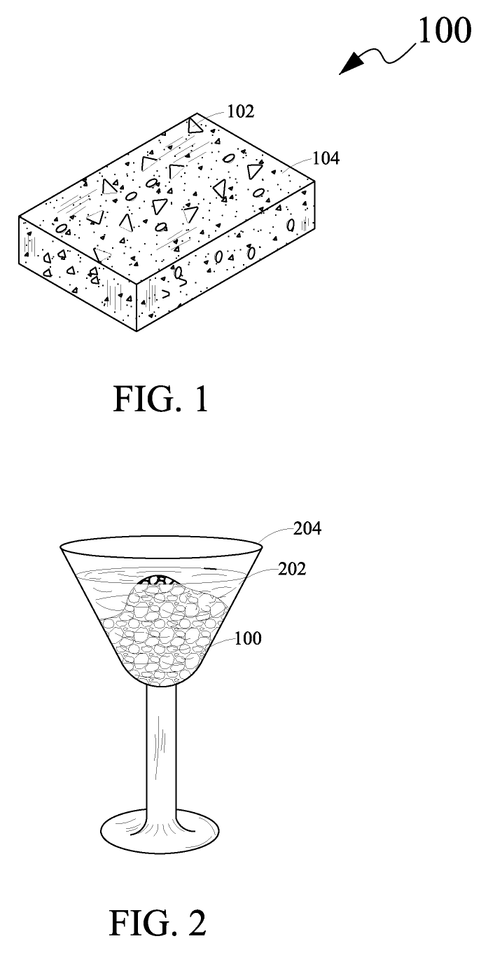

Referring to FIG. 1, a perspective view of a food product 100 in a frozen form is illustrated. The food product 100 includes at least one fruit 102 (hereinafter referred to as the fruit 102) and at least one fruit juice 104 (hereinafter referred to as the fruit juice 104). Examples of the fruit 102 may be include, but are not limited to apple, banana, mango, pineapple, orange, kiwi, cherry, strawberry, blueberry, cranberry, grape and combination thereof. The food product 100 may include fruit 102 in a peeled form or a cored form. Alternatively, the fruit 102 may be processed into a plurality of fruit pieces by at least one of a cutting process, a slicing process, a dicing process or a grating process. However, it will be apparent to a person skilled in the art that the plurality of fruit pieces may also be obtained by any other method.

Moreover, the fruit juice 104 may be selected from a group comprising apple juice, banana juice, mango juice, pineapple juice, orange juice, kiwi juice, cherry juice, strawberry juice, blueberry juice, cranberry juice, grape juice, or any combination thereof. In one embodiment of the present invention, the fruit juice 104 may be a commercially available fruit juice. Alternatively, the fruit juice 104 may be obtained from the fruits, for example the fruit 102, by crushing the fruit 102.

The food product 100 may be preferably consumed as a dessert. It should be apparent to a person skilled in the art that the food product 100 may be healthy for human consumption due to the presence of fresh fruit ingredients therein as mentioned before.

In an exemplary embodiment of the present invention, the food product 100 may include the fruit 102 and the fruit juice 104 in various ratios. For example, a consumer may prefer to consume a mango flavored food product including mango pieces and mango juice in a ratio of, for example, 50:50. In another exemplary embodiment of the present invention, the food product 100 may include one or more fruit 102 and one or more fruit juices 104 in various ratios. For example, the food product 100 may include apple pieces, pineapple pieces, apple juice, and pineapple juice in a ratio of 25:25:25:25. Accordingly, the aforementioned ratios of the fruits and fruit juices may be mixed in a container, thereby preparing a mixture. The mixture may be frozen to prepare the food product 100. It should be obvious to a person skilled in the art that these ratios of the fruit pieces and the fruit juices in the food product 100 are mentioned here for the purpose of understanding of the present invention and are not limited thereto. The food product 100 may be consumed as a dessert by a consumer.

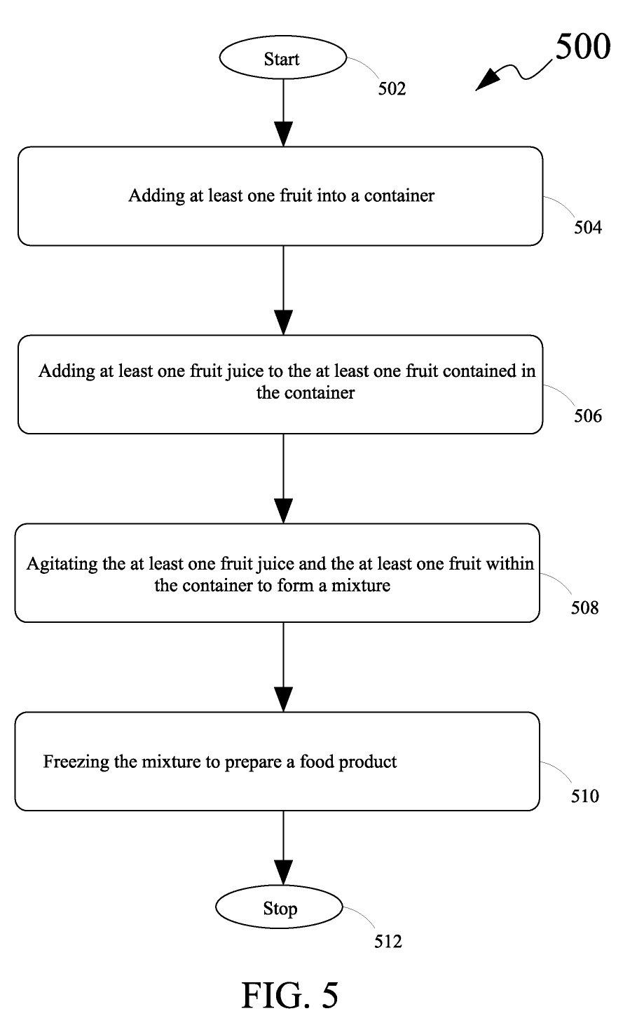

It will be understood that for the purpose of this description the fruit 102 and the fruit juice 104 are depicted in a frozen form in FIG. 1. However, the food product 100 is obtained from a mixture of the fruit 102 and the fruit juice 104 that is later frozen. A process for preparing the food product 100 will be explained further in conjunction with FIG. 5.

The food product 100 may further include additional ingredients. In one embodiment of the present invention, the food product 100 may include crushed ice (not shown in FIG. 1) and sweeteners (not shown in FIG. 1), as the additional ingredients. The crushed ice may be added to provide an icy frame with relatively smoother surface to the food product 100. The crushed ice may also provide extra coolness to a consumer while consuming the food product 100. Further, the sweeteners may include, but are not limited to honey, fruit syrup, corn syrup, and on the like. The sweeteners may provide additional flavor to the food product 100, thereby enhancing a taste thereof. The sweeteners used herein may depend upon consumer's choice and taste.

In one embodiment of the present invention, the food product 100 may further include a flavoring agent for providing a flavor to the food product 100. The flavoring agent may be a ginger ale, coffee, eggnog, or any other known flavoring agents. More specifically, the flavoring agent may be mixed with the food product 100 in a container, for example, a bowl or a glass. The flavoring agent added to the food product 100 may impart a refreshing taste to the food product 100. In another embodiment of the present invention, various types of flavoring agents may be added to the food product 100 in any ratios preferred by the consumer.

FIG. 2 illustrates a perspective view of the food product 100 blended with a drink 202, in accordance with another embodiment of the present invention. More specifically, the food product 100 may be blended with the drink 202 in a container, for example, a glass 204 prior to consumption. Examples of the drink 202 may include a non-alcoholic drink, a fruit juice, and a combination thereof. The drink 202 may enhance the taste of the food product 100.

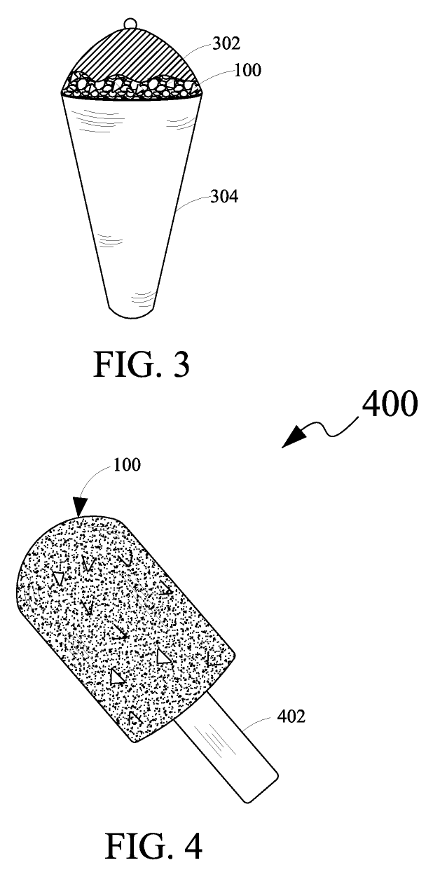

FIG. 3 illustrates a perspective view of the food product 100 including a garnishing material, for example, a garnishing material 302, in accordance with an embodiment of the present invention. Examples of the garnishing material 302 may include, but are not limited to cream, a cherry and combination thereof. The garnishing material 302 may enhance the taste and aesthetic value of the food product 100. Further, the food product 100 may be held in a cone, for example, a cone 304.

FIG. 4 illustrates perspective view of a food product package 400, according to an exemplary embodiment of the present invention. The food product package 400 may include the food product 100 and a holder, for example, a stick 402. Accordingly, the food product 100 may be held by the stick 402. The stick 402 may be composed of a wooden material, a plastic material, and the like. Other examples of the holder may include, a container, a plastic cup, a cone, a card board cup, and the like. The holder enables the consumer to hold the food product 100 conveniently while consuming the food product 100.

FIG. 5 illustrates a flow chart depicting a method 500 for preparing the food product 100, according to an exemplary embodiment of the present invention. The method for preparing the food product 100 starts at 502. At 504, at least one fruit may be added into a container. The at least one fruit may be selected from the group of fruits, including apple, banana, mango, pineapple, orange, kiwi, cherry, strawberry, blueberries, cranberry, grape and combination thereof.

In one embodiment of the present invention, the at least one fruit, for example the fruit 102, may be processed into a plurality of fruit pieces by a method selected from the group including cutting, slicing, dicing, and grating. The fruit 102 may be washed before being cut into the plurality of fruit pieces. Further, the fruit 102 may also be cored or peeled depending upon a type of fruit. For example, the fruit 102, such as pineapple, mango, apple, and the like, may be peeled or cored. Alternatively, the fruit 102 may be peeled and subsequently cored. In another embodiment of the present invention, the fruit 102 may not be peeled or cored. For example, the fruit 102 such as grape, cranberry, etc., may not be peeled or cored. In yet another embodiment of the present invention, the fruit 102 may be used as a whole fruit. For example, the fruit 102, such as grape, cranberry, etc., may be used as a whole fruit.

At 506, at least one fruit juice may be added to the at least one fruit within the container. The at least one fruit juice such as, the fruit juice 104 may be prepared by crushing at least one fruit selected from the group comprising apple, banana, mango, pineapple, orange, kiwi, cherry, strawberry, blueberry, cranberry, grape, and combination thereof. The at least one fruit of the abovementioned group may be either peeled fruit or cored fruit or a whole fruit. As mentioned previously, the fruit 102 and the fruit juice 104 may be mixed in a particular ratio.

Thereafter, the fruit 102 and the fruit juice 104 may be agitated within the container to form a mixture thereof at 508. The fruit 102 and the fruit juice 104 in the container may be agitated by a suitable means of agitating, for example, agitator, fomenter, stirrer, and the likes, to obtain the mixture.

At 510, the mixture may be frozen to obtain the food product 100. In one embodiment of the present invention, crushed ice and sweeteners may be added to the mixture as additional ingredients and subsequently frozen to obtain the food product 100. The crushed ice is obtained by crushing ice. The crushed ice added to the mixture provides an icy frame with relatively smoother surface to the food product 100. The crushed ice may also provide extra coolness to the user while consumption. Further, the sweeteners may include, but not limited to honey, fruits syrup, corn syrup, and so on. The sweeteners may be added to the mixture to enhance the flavor of the food product 100.

As illustrated in FIG. 2, in another embodiment of the present invention, the food product 100 may be blended with a liquid prior to consumption. The liquid may include, for example, non-alcoholic drinks, fruit juices, and the like. Further, with reference to FIG. 3, in yet another embodiment of the present invention, the food product 100 may be garnished with a garnishing material 302 as mentioned before. The garnishing material 302 may include, but not limited to cream, a cherry and combination thereof. The garnishing material 302 may enhance the taste of the food product 100.

The present invention provides a food product. The food product disclosed herein includes fresh fruit ingredients such as, fruits and fruit juices. The food product disclosed herein is healthy for human consumption due to the presence of fresh fruit ingredients therein. Accordingly, the food product may be consumed by people of all age groups and by the people undergoing medical treatment. Moreover, the food product disclosed herein may be packaged, thereby enabling a consumer to hold the food product effortlessly. Additionally, the food product may be prepared by a cost-effective and simple process.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. A food product, comprising:
at least one fruit; and
at least one fruit juice,
wherein the at least one fruit juice is mixed with the at least one fruit to form a mixture, the mixture capable of being frozen to prepare the food product.

2. The food product of claim 1, wherein the at least one fruit is selected from the group comprising apple, banana, mango, pineapple, orange, kiwi, cherry, strawberry, blueberry, cranberry, grape and combination thereof.

3. The food product of claim 1, wherein the at least one fruit juice is selected from the group comprising apple juice, banana juice, mango juice, pineapple juice, orange juice, kiwi juice, cherry juice, strawberry juice, blueberry juice, cranberry juice, grape juice and combination thereof.

4. The food product of claim 1, further comprising crushed ice.

5. The food product of claim 1, further comprising a sweetener.

6. The food product of claim 1, further comprising a flavoring agent.

7. The food product of claim 1, wherein the flavoring agent is selected from the group comprising ginger ale, coffee, and eggnog.

8. The food product of claim 1, further comprising a garnishing material capable of topping the mixture.

9. The food product of claim 8, wherein the garnishing material is at least one of a cream, a cherry and combination thereof.

10. A food product package, comprising:
a food product, wherein the food product is a mixture of at least one fruit and at least one fruit juice; and
a holder to accommodate the food product,
wherein the food product is in a frozen form.

11. The food product package of claim 10, wherein the holder is at least one of a stick, a container, and a comet.

12. A method of preparing a food product, the method comprising:
adding at least one fruit into a container;
adding at least one fruit juice to the at least one fruit contained in the container;
agitating the at least one fruit juice and the at least one fruit within the container to obtain a mixture; and
freezing the mixture to prepare the food product in a frozen form.

13. The method of claim 12, further comprising processing the at least one fruit into a plurality of fruit pieces.

14. The method of claim 13, wherein the processing is performed by at least one of cutting, slicing, dicing and grating.

15. The method of claim 12, wherein the at least one fruit is selected from the group comprising apple, banana, mango, pineapple, orange, kiwi, cherry, strawberry, blueberry, cranberry, grape and combination thereof.

16. The method of claim 12, further comprising adding a crushed ice to the mixture.

17. The method of claim 12, further comprising adding a sweetener to the mixture.

18. The method of claim 12, further comprising adding a flavoring agent into the mixture.

19. The method of claim 18, wherein the flavoring agent is selected from the group comprising ginger ale, coffee, and eggnog.

20. The method of claim 12, further comprising topping the mixture with a garnishing material, wherein the garnishing material is at least one of cream, a cherry and combination thereof.
